(19) United States
(12) Patent Application Publication
(10) Pub. No.: US 2016/0179516 A1
(43) Pub. Date: Jun. 23, 2016

(54) INFORMATION PROCESSING DEVICE AND CONTROL METHOD

(71) Applicant: FUJITSU LIMITED, Kawasaki-shi (JP)

(72) Inventor: Akira HOSOI, Atsugi (JP)

(21) Appl. No.: 14/854,076

(22) Filed: Sep. 15, 2015

(30) Foreign Application Priority Data
Dec. 19, 2014 (JP) 2014-257452

(51) Int. Cl. G06F 9/30

(52) U.S. Cl. CPC G06F 9/3001; G06F 9/30145

(57) ABSTRACT

An information processing device includes: an arithmetic processing device including a plurality of arithmetic processing units and a memory, wherein the arithmetic processing device configured to: estimate a first amount of operation in a given part of a program stored in the memory before execution of the program; determine a first arithmetic processing unit number indicating a number of arithmetic processing units that execute the given part, based on the first amount of operation and a reference value for parallelizing processing of the given part; and obtain a second arithmetic processing unit number by adjusting the first arithmetic processing unit number based on a second amount of operation when the given part is executed by the first arithmetic processing unit number and the reference value.

### CROSS-REFERENCE TO RELATED APPLICATION

This application is based upon and claims the benefit of priority of the prior Japanese Patent Application No. 2014-257452, filed on Dec. 19, 2014, the entire contents of which are incorporated herein by reference.

### FIELD

The embodiment discussed herein is related to an information processing device and a control method.

### BACKGROUND

In a central processing unit (CPU) referred to as a multi-core processor, a program is executed by a plurality of processor cores.

A related technology is disclosed in Japanese Laid-open Patent Publication No. 2012-145987, International Publication Pamphlet No. WO 2010/001766, Japanese Laid-open Patent Publication No. 2007-264734, Japanese Laid-open Patent Publication No. 2011-13716, or Japanese Laid-open Patent Publication No. 11-39155.

### SUMMARY

According to an aspect of the embodiments, an information processing device includes: an arithmetic processing device including a plurality of arithmetic processing units and a memory, wherein the arithmetic processing device configured to: estimate a first amount of operation in a given part of a program stored in the memory before execution of the program; determine a first arithmetic processing unit number indicating a number of arithmetic processing units that execute the given part, based on the first amount of operation and a reference value for parallelizing processing of the given part; and obtain a second arithmetic processing unit number by adjusting the first arithmetic processing unit number based on a second amount of operation when the given part is executed by the first arithmetic processing unit number and the reference value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of configuration of a node;

FIG. 2 illustrates an example of functions of the node;

FIG. 3 illustrates an example of relation between processing of a parallel program and a number of processor cores;

FIG. 4 illustrates an example of processing of a node; and

FIG. 5 illustrates an example of a part of a parallel program.

### DESCRIPTION OF EMBODIMENT

When a program is executed by a CPU referred to as a many-core processor, which is formed by increasing the number of processor cores of a multi-core processor, for example, a larger number of processor cores than when the program is executed by the multi-core processor are used.

Before parallel execution of the program by a plurality of processor cores, the execution time of the program is estimated, and an amount of transactions and the type of the processor are identified. The number of processor cores to be used to execute the program is determined accordingly. Information on tasks, functions, loops, and the like within the program which information is obtained by static analysis before the execution of the program is used for tuning the multi-core processor.

The number of times of iterative processing in the program, whether a condition is true or false in the execution of an if statement, and the like, for example, are indeterminate until the program is executed. It may therefore be difficult to determine the number of processor cores for executing the program based on analysis before the execution of the program by a compiler.

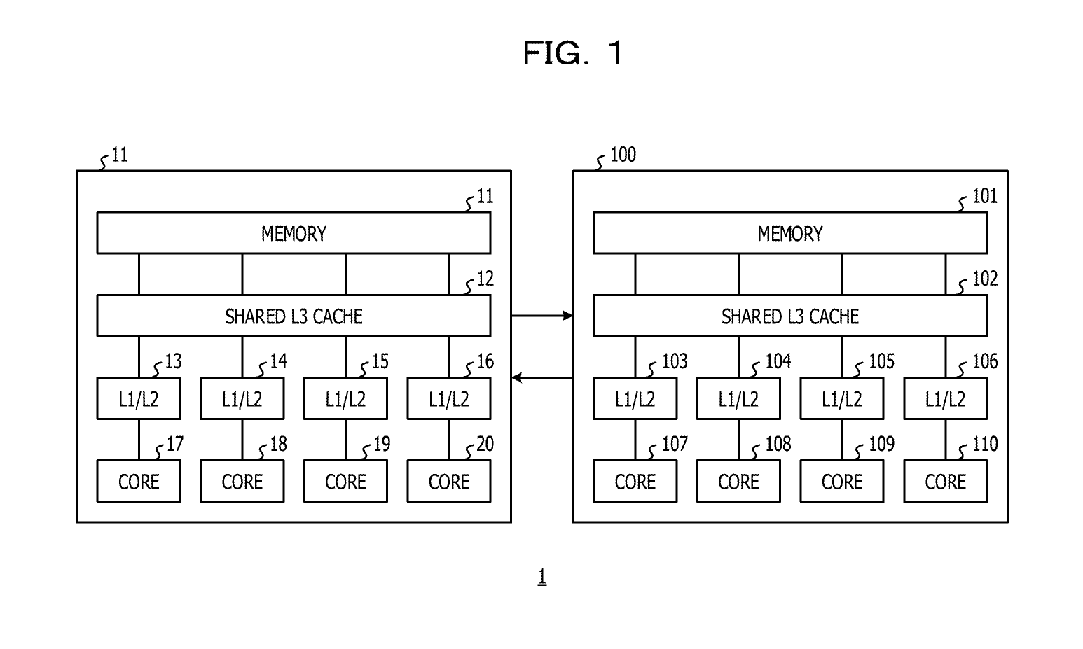

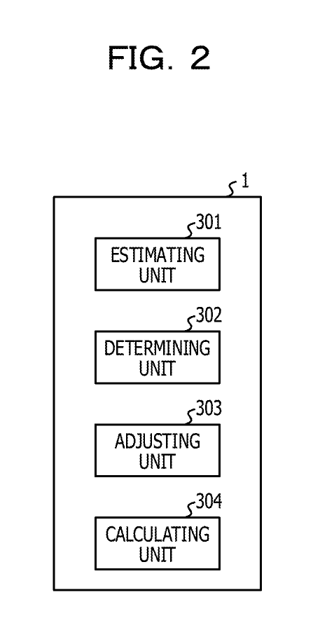

FIG. 1 illustrates an example of configuration of a node. FIG. 2 illustrates an example of functions of a node. As illustrated in FIG. 1, a node 1 includes CPUs 10 and 100 corresponding to two arithmetic processing devices, which each include processor cores (hereinafter referred to simply as “cores”) as a plurality of arithmetic processing units. The CPU 10 includes a memory 11 corresponding to a storage device, a shared L3 cache 12 corresponding to a cache memory (hereinafter referred to simply as a “cache”), four L1 caches/L2 caches 13 to 16, and four cores 17 to 20. The memory 11 is coupled to the shared L3 cache 12. The shared L3 cache 12 is coupled to each of the L1 caches/L2 caches 13 to 16. The L1 caches/L2 caches 13 to 16 are respectively coupled to the cores 17 to 20. The CPU 100 includes a memory 101, a shared L3 cache 102, four L1 caches/L2 caches 103 to 106, and four cores 107 to 110. A coupling configuration of the CPU 100 may be substantially the same as or similar to the coupling configuration of the CPU 10. The CPUs 10 and 100 may be a chip.

In the CPU 10, data to be used for the processing of the cores 17 to 20 is loaded from the memory 11 into the shared L3 cache 12. The cores 17 to 20 each store the data to be used for the processing in the L1 caches/L2 caches 13 to 16. The L1 caches of the L1 caches/L2 caches 13 to 16 may be cache memories accessed from the cores 17 to 20 to which the L1 caches are coupled, and may be cache memories having a highest access speed among the L1 to shared L3 caches. Two kinds of caches, for example, an L1-instruction (L1-I) cache storing instructions to the operation unit and an L1-data (L1-D) cache storing data are included, so that the program and the data may not interfere with each other.

The L2 caches of the L1 caches/L2 caches 13 to 16 may be cache memories accessed next when data to be used is not present in the L1-D caches. The L2 caches have a higher capacity than the L1 caches, whereas the speed of access to the L2 caches is lower than the speed of access to the L1 caches. The shared L3 cache may be a cache memory accessed next when the data to be used is not present in the L2 cache either. The shared L3 cache has a higher capacity than the L2 caches, while the speed of access to the shared L3 cache is lower than the speed of access to the L2 caches. Unlike the L1 caches/L2 caches 13 to 16 coupled to the respective cores 17 to 20, the shared L3 cache may be shared by the whole of the cores 17 to 20. Therefore, when data shared by the cores 17 to 20 is stored in the shared L3 cache, multithread processing, for example, in which one program is processed by a plurality of cores, is performed, so that the processing of the program may be increased in speed.

The node 1 functions as an estimating unit 301, a determining unit 302, an adjusting unit 303, or a calculating unit 304 illustrated in FIG. 2 by expanding various kinds of programs stored on a hard disk drive (HDD) or the like into the memory 11 and executing the programs using the CPU 10, for example. The estimating unit 301 estimates an amount of operation in a given part of a program executed by the CPU 10 before the execution of the program. The determining unit 302 determines a number of cores for executing the given part of the program based on the estimated amount of operation and a reference value for parallelizing the processing of the given part. The adjusting unit 303 adjusts the number of cores for executing the part of the program based on the amount of operation and the reference value when the given part of the program is executed by the number of cores determined by the determining unit 302. The calculating unit 304 calculates the reference value based on the granularity of processing per core of the processor and a processing load in parallel execution of the given part of the program.

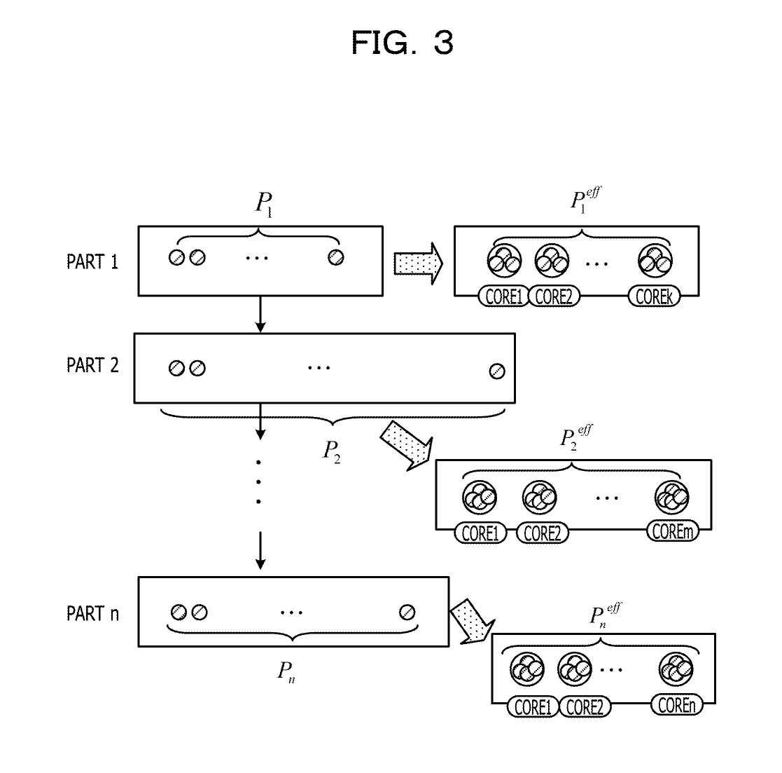

FIG. 3 illustrates an example of relation between processing of a parallel program and a number of processor cores. Processing in the parallel program may be divided into n parts 1 to n, for example. Each of the parts for example includes a loop or a plurality of functions that can be executed in parallel with each other. Each of the parts may for example have a loop parallelism or an inter-function parallelism. The loop parallelism and the inter-function parallelism may for example be referred to collectively as a theoretical parallelism. A value Pᵢ indicating a degree of theoretical parallelism of a part i is represented by the following Equation (1). Pᵢ is a natural number. The value Pᵢ may be the reference value for parallelizing the processing of the given part of the parallel program.

Pᵢ=Pᵢ(1≦i≦n) (1)

For the processing of the parallel program, the granularity of processing per core of the processor may be provided. The granularity may be an index of evaluation of a degree of parallelization of processing in the parallel program from a viewpoint of a calculation time and an amount of operation at a time of performance of the processing. The larger the granularity, the longer an execution time in the execution of the parallel program, for example a total time of a calculation time, a communication time, and a synchronization waiting time, but the better the efficiency of parallelization, because the processing is not fragmented. The smaller the granularity, the shorter the execution time taken for the execution of the parallel program, but the poorer the efficiency of parallelization, because the processing is fragmented. The efficiency of parallelization may be for example a ratio of the execution time of the parallel program to the processing time of the whole processing including processing attendant on parallelization, such as preparatory processing for the parallelization.

With regard to relation between the granularity and the value Pᵢ indicating the degree of theoretical parallelism, in the processing of the parallel program, a large granularity is set such that an effect of an improvement in efficiency of operation which effect is obtained by parallelizing the processing exceeds an effect of the processing attendant on the parallel execution, for example overhead. A value Pᵢ^{eff} indicating a degree of effective parallelism when the part i in the parallel program is executed in parallel is expressed by the following Equation (2). Pᵢ^{eff} is a natural number.

Pᵢ^{eff}=Pᵢ^{eff}(1≦i≦n) (2)

The value Pᵢ^{eff} indicating the degree of effective parallelism is equal to or less than the value Pᵢ indicating the degree of theoretical parallelism, and is represented by the following Equation (3), for example.

Pᵢ^{eff}≦Pᵢ (3)

The node 1 groups together Pᵢ tasks capable of parallelization in the part i of the parallel program as Pᵢ^{eff} parallel tasks, and uses Pᵢ^{eff} cores to make each core execute the parallel tasks one by one in parallel. As illustrated in FIG. 3, the number of cores for executing a part 1 of the program is set at Pᵢ^{eff} (=k), the number of cores for executing a part 2 of the program is set at P₂^{eff} (=m), and the number of cores for executing a part n of the program is set at Pₙ^{eff}.

A maximum value Pₘₐₓ^{eff} of values of the index Pᵢ^{eff} is expressed by the following Equation (4).

Pₘₐₓ^{eff}=maxPᵢ^{eff} (4)

When the number of cores of the CPU executing the parallel program is N_{core}, the following Equation (5) holds in a many-core processor where N_{core}=100 to 500, for example.

Pₘₐₓ^{eff}≦N_{core} (5)

In the processing of each part of the parallel program, the theoretical value of the number of cores to be used is equal to or less than the number of cores of the CPU. There may thus be a small possibility of a phenomenon occurring in which the number of cores is insufficient at a time of execution of the parallel program. Therefore, a code defined so as to perform the processing of each part of the parallel program using the Pᵢ^{eff} cores may be an appropriate code for the parallel program from a viewpoint of the number of cores.

The node 1 obtains the value Pᵢ of the index of theoretical parallelism for each part i (1≦i≦n) of the parallel program before actual execution of the parallel program, by using a dependency analysis routine provided to a compiler for a description language of the parallel program, such for example as C, C++, Java (registered trademark), or Scala. The dependency analysis routine obtains information on the number of times of loop processing, the number of instruction rows without dependency relation, or the like within each part of the parallel program, and calculates the value of Pᵢ based on the obtained information.

In the processing of the parallel program, there is an overhead caused by parallelization or the like, for example, the creation and disappearance of threads, barrier synchronization, or the like. Therefore, when an amount of operation per core is decreased with too many cores sharing the processing of the parallel program, the processing load of each core may be reduced, but an overall processing time may be lengthened. When the granularity of processing of the parallel program is too small, for example, the processing time of the parallel program may be lengthened.

The compiler regards the calculated value of Pᵢ as the number of tasks that can be theoretically processed in parallel with each other in the part i, and calculates the value of the index Pᵢ^{eff} indicating the degree of effective parallelism. The degree of effective parallelism is for example a suitable number of parallel tasks when the Pᵢ tasks are parallelized in consideration of the granularity. The compiler regards the calculated value of Pᵢ^{eff} as the number of cores for performing the processing of the part i, and creates a parallelized code corresponding to a binary program for performing the processing of the part i with the Pᵢ^{eff} cores.

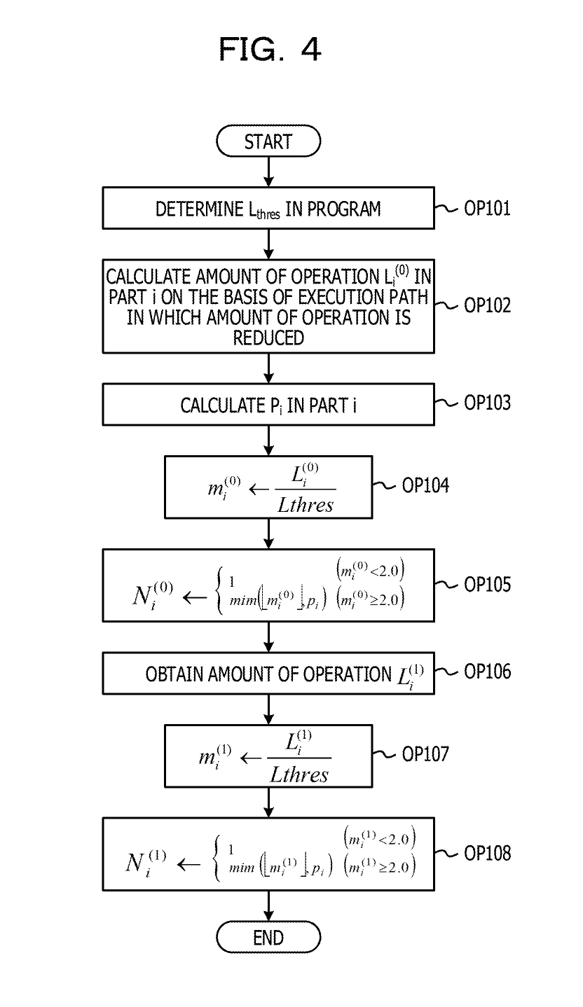

The number of cores to be used when performing the processing of the part i of the parallel program is determined and adjusted. FIG. 4 illustrates an example of processing of a node.

In OP101, the node 1 determines the value of the granularity when the parallel program is executed. For example, the node 1 sets, as a threshold Lₜₕᵣₑₛ, an upper limit value of the granularity such that the processing time of the parallel program does not become longer as the granularity is made smaller. The value of the threshold Lₜₕᵣₑₛ differs depending on an execution environment. The node 1 for example determines the value of Lₜₕᵣₑₛ by executing a test program in advance. The test program may be a program in which a portion of the parts i of the parallel program to be executed is executed. The node 1 repeatedly executes the test program while changing the number of cores, and determines the value of the threshold Lₜₕᵣₑₛ as a granularity suitable for executing the test program. After the node 1 determines the value of the threshold Lₜₕᵣₑₛ for the part i, the processing proceeds to OP102.

In OP102, the node 1 statically estimates an amount of operation in the part i of the parallel program. For example, the node 1 calculates an amount of operation in each part i of the program at a time of compilation of the parallel program. The amount of operation in the part i may be for example the processing time of a source code of the parallel program, the number of executable instructions in the part i within an object code, or the like. The statically estimated value of the amount of operation in the part i which amount of operation is calculated by the node 1 in OP102 is calculated as Lᵢ⁽⁰⁾.

The presence of a conditional branch or the like within the part i may cause the estimated amount of operation to differ depending on a path selected from execution paths within the part i. When an execution path to be selected at the time of the compilation is not identified, the node 1 assumes that an execution path in which the amount of operation is reduced is selected and executed, and estimates the amount of operation in the part i. The processing proceeds to OP103.

In OP103, the value Pᵢ of the number of tasks that can be theoretically processed in parallel with each other is calculated based on the number of pieces of loop processing, the number of instruction rows without dependency relation, or the like in the part i. The processing proceeds to OP104. In OP104, an evaluation value mᵢ⁽⁰⁾ represented in the following Equation (6) is calculated using the threshold Lₜₕᵣₑₛ and the calculated estimated value Lᵢ⁽⁰⁾. As represented in Equation (6), the evaluation value mᵢ⁽⁰⁾ is a value obtained by dividing the estimated amount of operation in the part i by the amount of operation per core.

$${m}_{i}^{( 0 )} = \frac{{L}_{i}^{( 0 )}}{{L}_{thres}} \qquad ( 6 )$$

The processing of the part i is performed with a number of cores which number is an integer and a value smaller than the value of the index Pᵢ of theoretical parallelism in the part i of the parallel program. In OP105, the number of cores Nᵢ⁽⁰⁾ assigned to the processing of the part i is calculated by the following Equation (7).

$${N}_{i}^{( 0 )} = \{ \begin{matrix}1 ( {m}_{i}^{( 0 )} < 2.0 ) \\ min ( ⌊ {m}_{i}^{( 0 )} ⌋ , {P}_{i} ) ( {m}_{i}^{( 0 )} \geq 2.0 )\end{matrix} \\ ⌊ {m}_{i}^{( 0 )} ⌋ \qquad ( 7 )$$

represents an integer not exceeding mᵢ⁽⁰⁾. The number of cores Nᵢ⁽⁰⁾ assigned to the processing of the part i by Equation (7) may be calculated as a number that is one or which does not exceed Pᵢ.

As represented in Equation (7), while the estimated value of the amount of operation calculated in OP104 does not exceed 2.0 times the amount of operation per core, the number of cores for performing the processing of the part i is set at one. When the estimated value of the amount of operation calculated in OP104 is equal to or more than 2.0 times the amount of operation per core, the number of cores for performing the processing of the part i is set at a value not exceeding Pᵢ in accordance with increase in the estimated value.

The number of cores of the CPU which are assigned to the performance of the processing of the part i is determined so as to be equal to or less than the number of cores determined based on theoretical parallelism, for example so as to satisfy Equation (3).

In OP106, the node 1 executes the part i using a number of cores which is determined in OP105, and calculates an amount of operation Lᵢ⁽¹⁾ at a time of the execution based on a result of the execution. In OP107, as in OP104, the node 1 calculates an evaluation value mᵢ⁽¹⁾ represented in the following Equation (8) using the threshold Lₜₕᵣₑₛ and the amount of operation Lᵢ⁽¹⁾ calculated in OP106.

$${m}_{i}^{( 1 )} = \frac{{L}_{i}^{( 1 )}}{{L}_{thres}} \qquad ( 8 )$$

In OP108, as in OP105, the node 1 calculates a number of cores Nᵢ⁽¹⁾ to be assigned to the processing of the part i of the parallel program by using the following Equation (9).

$${N}_{i}^{( 1 )} = \{ \begin{matrix}1 ( {m}_{i}^{( 1 )} < 2.0 ) \\ min ( ⌊ {m}_{i}^{( 1 )} ⌋ , {P}_{i} ) ( {m}_{i}^{( 1 )} \geq 2.0 )\end{matrix} \qquad ( 9 )$$

Equations (8) and (9) may be similar to Equations (6) and (7), respectively, and therefore detailed description of Equations (8) and (9) may be omitted. The following Equation (10) holds.

Nᵢ⁽¹⁾≧Nᵢ⁽⁰⁾ (10)

The node 1 can estimate the number of cores for executing the part i of the parallel program by using Equation (7), and adjust the estimated number of cores to a more suitable number of cores by using the number of cores calculated by Equation (9). The amount of operation in the part i is calculated more accurately by tentatively determining the number of cores for executing the part i by using Equation (7). For example, when the number of cores is not estimated nor tentatively determined, the number of cores for performing the processing of the part i may be too large, and the granularity may be too small. For example, even when the amount of operation in the part i is increased, the processing of the part i may be performed with a largest possible number of cores while operation time is shortened.

When the amount of operation in each part i is estimated in OP102, a path in which the amount of operation is reduced is assumed to be selected and executed. When the part i is actually executed, for example, the path in which the amount of operation is reduced is not necessarily selected. Thus, the amount of operation estimated by the node 1 in OP102 is equal to or less than the amount of operation when the part i is actually executed. In OP107, the number of cores is determined based on the value of mᵢ⁽¹⁾ calculated based on the amount of operation in the part i in OP106. The number of cores for executing the part i may be adjusted such that the present number of cores is either maintained or increased. The number of cores may be precluded from continuing to be increased or decreased repeatedly and not being readily determined. Therefore, the number of cores for executing the part i may be maintained to be a suitable number of cores by the adjustment of the number of cores.

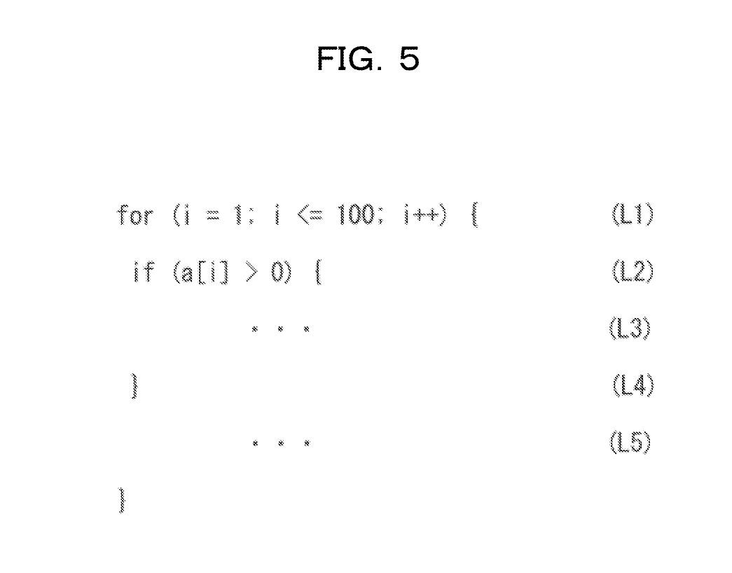

FIG. 5 illustrates an example of a part of a parallel program. For example, a certain part of the parallel program, for example, a part corresponding to one of parts i of the parallel program may be a source code illustrated in FIG. 5. In FIG. 5, (L1) to (L5) are added for the convenience of description, and may not affect the compilation of the source code, the performance of processing, or the like.

As a result of compiler execution by the node 1, a statically estimated value of the index Pᵢ of theoretical parallelism may be calculated to be 100. It is not clear at a time of compilation whether a condition in an if statement in the “(L2)” row illustrated in FIG. 5 holds or does not hold. The node 1 may determine from the result of the compiler execution that the amount of operation in the case where the condition in the if statement does not hold is smaller than the amount of operation in the case where the condition in the if statement holds. As a result, the node 1 may assume that the condition in the if statement does not hold and then the part i is executed. The node 1 may estimate the amount of operation in the (L2) to (L6) rows, and calculate that the number of cores for executing the part is two based on the estimated amount of operation, by performing the processing of OP104 and OP105.

The node 1 obtains an amount of operation when the part is executed by using two cores in OP106. The node 1 calculates that the number of cores for executing the part is five, by performing the processing of OP107 and OP108. The node 1 executes the part using five cores when executing the part next time.

The number of cores for executing the part of the parallel program which part is illustrated in FIG. 5 may be adjusted to a more suitable number of cores by performing the processing of OP101 to OP108. Even when a developer not skilled in the development of parallel programs creates a program, for example, the processing of each part may be performed after the number of cores to be used for each part of the program is adjusted to a more suitable number of cores.

In FIG. 3, for example, tasks are equally assigned to each core that executes the part i. However, the number of tasks assigned to each core may be changed as appropriate.

A management tool for making settings in the information processing device, an operating system (OS), or a program for performing other functions may be recorded on a recording medium readable by a computer or another machine or device (hereinafter a computer or the like). A function is provided by the computer or the like reading and executing the program on the recording medium. The computer may be for example a node or the like.

The recording medium readable by the computer or the like refers to a recording medium that stores information such as data and a program by electric, magnetic, optical, mechanical, or chemical action and can be read from the computer or the like. Recording media removable from the computer or the like among such recording media may include for example a flexible disk, a magneto-optical disk, a compact disc read only memory (CD-ROM), a compact disc rewritable (CD-R/W), a digital versatile disc (DVD), a Blu-ray disc, a digital audio tape (DAT), an 8-mm tape, a memory card such as a flash memory, and the like. Recording media fixed to the computer or the like may include a hard disk, a ROM, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising
an arithmetic processing device including a plurality of arithmetic processing units and a memory,
wherein the arithmetic processing device configured to:
estimate a first amount of operation in a given part of a program stored in the memory before execution of the program;
determine a first arithmetic processing unit number indicating a number of arithmetic processing units that execute the given part, based on the first amount of operation and a reference value for parallelizing processing of the given part; and
obtain a second arithmetic processing unit number by adjusting the first arithmetic processing unit number based on a second amount of operation when the given part is executed by the first arithmetic processing unit number and the reference value.

2. The information processing device according to claim 1,
wherein when the given part includes a plurality of execution paths, the arithmetic processing device estimates the first amount of operation based on an execution path in which an amount of operation is smaller among the plurality of execution paths.

3. The information processing device according to claim 1,
wherein the arithmetic processing device calculates the reference value based on granularity of processing per arithmetic processing unit of the plurality of arithmetic processing units and a processing load in parallel execution of the given part.

4. The information processing device according to claim 1,
wherein the reference value is determined on a basis of a number of pieces of loop processing included in the given part or a number of instructions without dependency relation included in the given part.

5. The information processing device according to claim 1,
wherein the second arithmetic processing unit number is equal to or more than the first arithmetic processing unit number.

6. A control method, comprising:
estimating, by an information processing device, a first amount of operation in a given part of a program to be executed by an arithmetic processing device including a plurality of arithmetic processing units before execution of the program;
determining a first arithmetic processing unit number indicating a number of arithmetic processing units that execute the given part based on the first amount of operation and a reference value for parallelizing processing of the given part of the program; and
obtaining a second arithmetic processing unit number by adjusting the first arithmetic processing unit number based on a second amount of operation when the given part is executed by the first arithmetic processing unit number and the reference value.

7. The control method according to claim 6,
wherein when the given part includes a plurality of execution paths, the first amount of operation is estimates based on an execution path in which an amount of operation is smaller among the plurality of execution paths.

8. The control method according to claim 6,
wherein the reference value is calculated based on granularity of processing per arithmetic processing unit of the plurality of arithmetic processing units and a processing load in parallel execution of the given part.

9. The control method according to claim 6,
wherein the reference value is determined based on a number of pieces of loop processing included in the given part or a number of instructions without dependency relation included in the given part.

10. The control method according to claim 6,
wherein the second arithmetic processing unit number is equal to or more than the first arithmetic processing unit number.
